(19) United States
(12) Patent Application Publication
(10) Pub. No.: US 2010/0268971 A1
(43) Pub. Date: Oct. 21, 2010

(54) METHOD AND APPARATUS FOR REDUCING POWER CONSUMPTION DURING WIRELESS DATA TRANSFER

(75) Inventors: Teng Pin Poo, Singapore (SG); Henry Tan, Singapore (SG)

Correspondence Address: FOLEY AND LARDNER LLP;SUITE 500, 3000 K STREET NW, WASHINGTON, DC, 20007, US

(73) Assignee: Trek 2000 International Ltd.

(21) Appl. No.: 12/742,092

(22) PCT Filed: Nov. 9, 2007
(86) PCT No.: PCT/SG2007/000385

§ 371 Date: May 7, 2010

(51) Int. Cl. G06F 1/32

(52) U.S. Cl. 713/320

(57) ABSTRACT

Apparatus for reducing power consumption during wireless data transfer between a host device and another device is disclosed. The apparatus comprises a plurality of wireless modules, each of the plurality of wireless modules comprising a different wireless protocol, each wireless protocol having a different transmission range and data transfer rate. The apparatus also comprises a processor having a determination module. The determination module is configured to determine which of the plurality of wireless protocols is able to be used for the wireless data transfer, and which of the different wireless protocols able to be used for the wireless data transfer has a power consumption that is the lowest of the wireless protocols able to be used for the wireless data transfer, the wireless protocol so determined being used for the wireless data transfer. A corresponding method is also disclosed.

### TECHNICAL FIELD

This invention relates to a method and apparatus for reducing power consumption during wireless data transfer and refers particularly, though not exclusively, to such a method and apparatus for reducing power consumption during wireless data transfer by selection of a wireless protocol from a plurality of available wireless protocols.

### BACKGROUND

Wireless connectivity has become part of daily life. It is used regularly for work, private purposes, and information retrieval. It is used almost anywhere. Wireless connectivity needs power. Quite often wireless connectivity is used to transfer data between a portable device and a computer device. Such a computer device may include, but is not limited to, a personal computer, laptop computer, a notebook computer, a tablet computer, a PDA, mobile telephone, and so forth. The portable device may be a peripheral device, portable data storage device, portable music or media player, or the like. Quite often the computer device and/or the portable device may be relying on battery power. When relying on battery power, power management becomes an important issue to extend the time in which the battery is able to operate. Even if the portable device and/or computer device is on mains power, the reduction of power consumption is recommended to reduce electricity use, and/or to control heat generation. Many such portable devices and computer devices use techniques such as, for example, the automatic transference to stand-by mode, or auto shutdown, after a defined period of non-use. These do not reduce power consumption during normal use.

### SUMMARY

In accordance with an exemplary aspect there is provided apparatus for reducing power consumption during wireless data transfer between a host device and another device, the apparatus comprising: a plurality of wireless modules, each of the plurality of wireless modules comprising a different wireless protocol, each wireless protocol having a different power consumption rating and data transfer rate; and a processor having a determination module; the determination module being configured to determine which of the plurality of wireless protocols is able to be used for the wireless data transfer, the determination module being configured to determine which of the different wireless protocols able to be used for the wireless data transfer has a power consumption that is the lowest of the wireless protocols able to be used for the wireless data transfer, the wireless protocol so determined being used for the wireless data transfer.

According to another exemplary aspect there is provided a method for reducing power consumption during wireless data transfer between a host device and another device, both the host device and the another device comprising a plurality of wireless modules, each of the plurality of wireless modules comprising a different wireless protocol, each wireless protocol having a different transmission range and data transfer rate; the method comprising:
using a processor having a determination module to determine which of the plurality of wireless protocols is able to be used for the wireless data transfer;
using the determination module to determine which of the different wireless protocols able to be used for the wireless data transfer has a power consumption that is the lowest of the wireless protocols able to be used for the wireless data transfer; and
using the wireless protocol so determined for the wireless data transfer.

For both exemplary aspects, the different wireless protocols may comprise a first wireless protocol having a first wireless transmission range and a first data transfer rate; and a second wireless protocol having a second wireless transmission range and a second data transfer rate. The determination of which of the wireless protocols has the lowest power consumption may be by determining a range for the wireless data transfer and then determining which of the wireless protocols is able to transmit data over that range, and using the wireless protocol having the lowest range. Alternatively or additionally, the determination of which of the wireless protocols has the lowest power consumption may be by determining which of the wireless protocols has the lowest transmission power rating, and using the wireless protocol having the lowest transmission power rating. Additionally or alternatively, the determination of which of the wireless protocols has the lowest power consumption may be by determining a size of the data to be transferred then determining which of the wireless protocols has the lowest data transmission rate able to transmit the data, and using the wireless protocol with the lowest data transmission rate. The determining of the range may be by gauging the power of transmission necessary to receive a response. During a detecting or scanning mode, transmission power may be increased until a response is received. The transmission may be by at least one of: the host, and the other device.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a schematic perspective view of a computer device and a portable device for wireless data transfer between the computer device and the portable device, one of the portable device and the computer device having an exemplary apparatus for reducing power consumption during the wireless data transfer;

FIG. 2 is an exemplary block diagram of the exemplary apparatus for reducing power consumption during the wireless data transfer; and

FIG. 3 is an exemplary flow chart for the operation of the exemplary apparatus of FIG. 2.

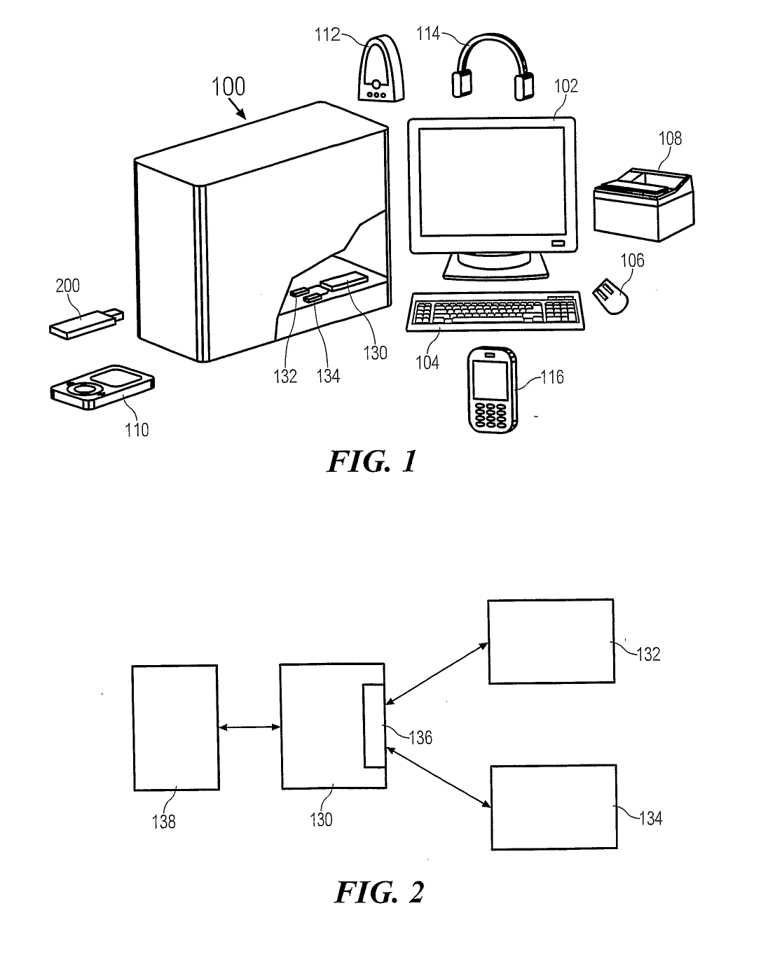

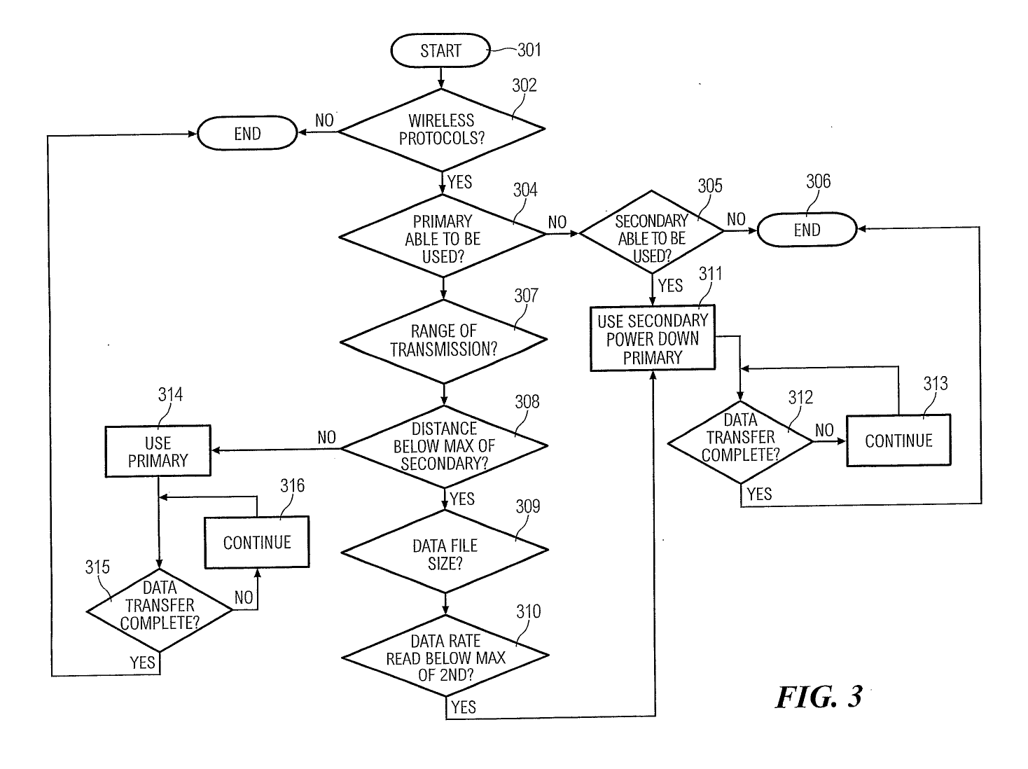

### DETAILED DESCRIPTION OF EXEMPLARY EMBODIMENTS

The exemplary embodiment illustrated relates to the reduction in power consumption during a wireless data transfer between a host device 100 and another device such as, for example, a portable data storage device 200. The other device may also be a computer peripheral device such as, for example, a monitor 102, keyboard 104, mouse 106, printer 108, portable media player 110, sound reproduction apparatus such as, for example, speakers 112 or headphones 114, or mobile telephone 116. The host device may be a personal computer 100 (as illustrated) or may be a laptop computer, notebook computer, tablet computer, personal digital assistant, mobile telephonic device, or other similar device having a central processor unit 130.

The power saving may be by performing the data transfer using a wireless transfer protocol of lower power consumption. Each of the host 100 and other device 200 has a plurality of wireless protocols, with there being at least two different wireless protocols in the two devices 100, 200 that are common to the two devices 100, 200. As shown the CPU 130 is operatively connected to two wireless modules 132, 134. The first, or prime, wireless module 132 is of a higher power, and thus higher power consumption, than the secondary wireless module 134. The CPU 130 includes a determination module 136 that is able to determine which of the two wireless modules 132, 134 should be used to reduce power consumption during data transfer. The CPU is also operatively connected to a memory module 138.

When determining which of the wireless modules 132, 134 is to be used for a particular data transfer, the determination module 136 will take into account a number of factors including, but not limited to:
the size of the data to be transferred;
the distance over which the data is to be transferred;
the data transfer rate of each of the wireless modules 132, 134; and
the transmission power of each of the wireless modules 132, 134.

For example, the wireless module 132 may have a higher data transfer rate and a higher transmission power to thus be able to transmit over a longer distance; while the wireless module 134 may have a lower data transfer rate and a lower transmission power so it can only transmit over a shorter distance. The secondary wireless protocol 134 is the preferred wireless protocol to use for power consumption reasons as it has the lower rate of power consumption. However, the primary wireless protocol 132 is the default wireless protocol as it is able to be used to make the early determinations, as will be understood from the following description.

For a simple illustration the wireless module 132 may be WiFi 802.11 and is the main wireless connectivity used by the host 100; and the second wireless module 134 may be Bluetooth and is the secondary wireless connectivity used by the host 100.

Both the host 100 and the other device 200 will have both wireless modules 132, 134. The main wireless connectivity module 132 (WiFi 802.11) will be used as the default wireless protocol.

When data transfer with (i.e. to and/or from) the other device 200 is required (301), the host 100 uses the primary protocol 132 to interrogate the other device 200 to first determine if the data transfer can take place using either of the wireless protocols 132, 134 (302). If not, the process ends (303). This may be due to the other device 200 being out of range of the host 100 for the two wireless protocols 132, 134; or that the other device 200 does not have a suitable wireless protocol for the host 100.

If yes at (302) a determination is made if the main protocol 132 can be used (304). If not (e.g. the other device 200 does not have the protocol 132) a further determination will be made (305) for the secondary protocol 134. If not at (305) (e.g. the other device 200 does not have the protocol 134) the process ends (306).

If yes at (304), a query is raised to determine the transmission range for the data transfer (307). The transmission range can be determined by gauging the power of transmission of the host 100 and/or portable device 200 necessary to receive a response. During detecting or scanning mode, the transmission power will be slowly increased until the portable device 200 becomes within in transmission range. When a response is received it is possible to determine the range of the other of the host 100 or portable device 200. A query is then raised to determine if the transmission range is below the maximum range of the secondary protocol 134 (308). If yes at (308) a further query is raised to determine the file size for data transfer (309) then if the required data transfer rate is below the maximum data transfer rate of the secondary protocol 134 (310). If yes at (310) or at (305), the secondary protocol 134 is used for the data transfer (311). After the data transfer starts a query is raised to determine if the data transfer is complete (312). If yes, the process ends (306). If no at (312) the data transfer continues (313) and the query is again raised (312). This repeats until the data transfer is complete.

If no at (308) or at (310) the primary protocol 132 is used for the data transfer (314). After the data transfer starts a query is raised to determine if the data transfer is complete (315). If yes, the process ends (303). If no at (315) the data transfer continues (316) and the query (315) is again raised. This continues until the data transfer is complete.

When the primary protocol 132 is used, the secondary protocol 134 is powered down or suspended in sleep mode until the next data transfer between the host 100 and another device 200. When the secondary protocol 134 is used, the primary protocol 132 is powered down or suspended in sleep mode until the next data transfer between the host 100 and another device 200.

Instead of range, power consumption may be used in the query of (307). Also, instead of determining if the range is below the maximum range of the secondary wireless protocol 134, the determination may be to determine if the range is above the maximum range of the secondary wireless protocol 134, in which case the primary wireless protocol 132 is used.

The range, power consumption and data transfer rates of the wireless protocols 132, 134 will be stored in processor 130 or memory 138 and may be in the form of a look-up table.

Whilst there has been described in the foregoing description exemplary embodiments, it will be understood by those skilled in the technology concerned that many variations in details of design, construction and/or operation may be made without departing from the present invention.

1. Apparatus for reducing power consumption during wireless data transfer between a host device and another device, the apparatus comprising:
a plurality of wireless modules, each of the plurality of wireless modules comprising a different wireless protocol, each wireless protocol having a different transmission range and data transfer rate; and
a processor having a determination module;
the determination module being configured to determine which of the plurality of wireless protocols is able to be used for the wireless data transfer, and which of the different wireless protocols able to be used for the wireless data transfer has a power consumption that is the lowest of the wireless protocols able to be used for the wireless data transfer, the wireless protocol so determined being used for the wireless data transfer.

2. Apparatus as claimed in claim 1, wherein the different wireless protocols comprise a first wireless protocol having a first wireless transmission range and a first data transfer rate; and a second wireless protocol having a second wireless transmission range and a second data transfer rate.

3. Apparatus as claimed in claim 1, wherein the determination module is configured to determine which of the wireless protocols has the lowest power consumption by determining a range for the wireless data transfer and then determining which of the wireless protocols is able to transmit data over that range, the wireless protocol having the lowest range being the wireless protocol used for the data transfer.

4. Apparatus as claimed in claim 1, wherein the determination module is configured to determine which of the wireless protocols has the lowest power consumption by determining which of the wireless protocols has the lowest transmission power rating, the wireless protocol having the lowest transmission power rating being the wireless protocol used for the data transfer.

5. Apparatus as claimed in claim 1, wherein the determination module is configured to determine which of the wireless protocols has the lowest power consumption by determining a size of the data to be transferred then determining which of the wireless protocols has the lowest data transmission rate able to transmit the data, the wireless protocol with the lowest data transmission rate being the wireless protocol used for the data transfer.

6. A method for reducing power consumption during wireless data transfer between a host device and another device, both the host device and the another device comprising a plurality of wireless modules, each of the plurality of wireless modules comprising a different wireless protocol, each wireless protocol having a different transmission range and data transfer rate; the method comprising:
using a processor having a determination module to determine which of the plurality of wireless protocols is able to be used for the wireless data transfer;
using the determination module to determine which of the different wireless protocols able to be used for the wireless data transfer has a power consumption that is the lowest of the wireless protocols able to be used for the wireless data transfer; and
using the wireless protocol so determined for the wireless data transfer.

7. A method as claimed in claim 6, wherein the different wireless protocols comprise a first wireless protocol having a first wireless transmission range and a first data transfer rate; and a second wireless protocol having a second wireless transmission range and a second data transfer rate.

8. A method as claimed in claim 6, wherein the determination of which of the wireless protocols has the lowest power consumption is by determining a range for the wireless data transfer and then determining which of the wireless protocols is able to transmit data over that range, and using the wireless protocol having the lowest range.

9. A method as claimed in claim 6, wherein the determination of which of the wireless protocols has the lowest power consumption is by determining which of the wireless protocols has the lowest transmission power rating, and using the wireless protocol having the lowest transmission power rating.

10. A method as claimed in claim 6, wherein the determination of which of the wireless protocols has the lowest power consumption is by determining a size of the data to be transferred then determining which of the wireless protocols has the lowest data transmission rate able to transmit the data, and using the wireless protocol with the lowest data transmission rate.

11. A method as claimed in claim 8, wherein the determining of the range is by gauging the power of transmission necessary to receive a response.

12. A method as claimed in claim 11, wherein during a detecting or scanning mode, transmission power is increased until a response is received.

13. A method as claimed in claim 11, wherein the transmission is by at least one selected from the group consisting of: the host, and the other device.
